(19) United States
(12) Patent Application Publication
(10) Pub. No.: US 2012/0318021 A1
(43) Pub. Date: Dec. 20, 2012

(54) APPARATUS FOR MANUFACTURING VITREOUS SILICA CRUCIBLE

(75) Inventors: Toshiaki SUDO, Akita-shi (JP); Hiroshi KISHI, Akita-shi (JP); Takeshi FUJITA, Akita-shi (JP); Minoru KANDA, Akita-shi (JP)

(73) Assignee: JAPAN SUPER QUARTZ CORPORATION, Akita-shi (JP)

(21) Appl. No.: 13/592,734

(22) Filed: Aug. 23, 2012

Related U.S. Application Data
(62) Division of application No. 13/095,472, filed on Apr. 27, 2011.

(51) Int. Cl. C03B 20/00

(52) U.S. Cl. 65/29.19

(57) ABSTRACT

Provided is an apparatus for manufacturing a vitreous silica crucible, which is capable of stably manufacturing a high quality vitreous silica crucible by stabilizing heat generation through an arc discharge. The apparatus for manufacturing a vitreous silica crucible includes a mold that defines a shape of a vitreous silica crucible, carbon electrodes that generate an arc discharge for fusing a silica powder molded body formed in the mold, and a power supply device that supplies power to the carbon electrodes. The power supply device includes a saturable reactor that is provided on a supply path of the power to the carbon electrodes and has variable reactance, and a control device that controls the power supplied to the carbon electrodes by changing the reactance of the saturable reactor.

This application is a division of U.S. patent application Ser. No. 13/095,472 filed Apr. 27, 2011, which is incorporated herein by reference in its entirety.

### BACKGROUND OF THE INVENTION

1. Field of the Invention

The present invention relates to an apparatus for manufacturing a vitreous silica crucible used for fabrication of silicon single crystal or the like.

2. Description of Related Art

The Czochralski method is one of the most popular methods of fabricating silicon single crystal. The Czochralski method is a method of fabricating silicon single crystal by forming silicon melt by heating polycrystalline silicon housed in a vitreous silica crucible by using a heater and growing high purity silicon single crystal to be a seed crystal, by dipping high purity single crystalline silicon into the silicon melt and pulling up the high purity single crystalline silicon. If a vitreous silica crucible containing an impurity is used in the fabrication of silicon single crystal, silicon single crystal containing the impurity is fabricated. To avoid this, a vitreous silica crucible containing very little impurities is used for fabrication of silicon single crystal.

A vitreous silica crucible used for fabrication of silicon single crystal or the like is manufactured by turning high purity silica powder to vitreous silica by heating and fusing the high purity silica powder. JP-A-hei 11-236233 discloses a method of manufacturing a vitreous silica crucible having a transparent vitreous silica layer formed inside an opaque vitreous silica layer by fusing raw silica powder molded to a shape of a crucible via an n-phase alternating n-electrode arc discharge (here, n≧3) and holding the molten raw silica under depressurized conditions.

### SUMMARY OF THE INVENTION

However, to acquire an arc discharge according to the technical configuration disclosed in JP-A-hei 11-236233 or the like, a power supply device, which uses power supplied from a commercial power grid as power for acquiring the arc discharge, is required. However, voltage of a commercial power grid supplied to a power supply device may vary (e.g., by about ±10%), and thus power supplied to an electrode, which generates the arc discharge, may also vary. As a result, a molten state of raw silica powder is not stable, and thus it is difficult to stably manufacture a high quality vitreous silica crucible having a transparent vitreous silica layer with a uniform thickness and a significantly small number of bubbles.

Furthermore, according to the technical configuration disclosed in JP-A-hei 11-236233 or the like, heating is performed as a distance between a carbon mold and an electrode is changed, and more particularly, as height positions of the electrode are changed. Here, it is controlled such that, according to changes in height (position) of an electrode, a desired distribution of a heating state of raw silica on the inner surface of the mold is acquired through local heating, and thus a desired inner surface property of a manufactured vitreous silica crucible may be achieved.

Furthermore, in addition to the controlling of inner surface heating distribution, it is necessary to control the total amount of heating (controlling a total amount of heat input) for weight control in manufacturing of a vitreous silica crucible. This is because, although an approximate number for a total amount of heating is calculated via time integration of an amount of supplied power, changes in the distance (positions) between a mold and an electrode appear to be significantly affected by changes in the amount of heat inputted to the raw powder.

In manufacturing a crucible using a rotation molding method, if the total amount of heating is changed, the amount of raw powder to be fused from among raw powder deposited in a mold is changed in the thickness-wise direction of the raw powder layer (the diameter-wise direction of the mold when viewed from a sidewall of the crucible; the thickness-wise direction of the crucible corresponding to vertically upward and downward directions when viewed from the bottom of the crucible). In other words, in an arc fusing process, the entire surface of molded raw powder corresponding to the entire inner surface of the mold is molten and a non-molten raw powder layer having a thickness of about 1 mm (0.3˜1.5˜2 mm) remains on the outer surface of a molten silica layer (the surface at the side of the mold), which is molten and integrated as a single body, when heating in the arc fusing process is completed. However, thicknesses of the molten silica layer and the non-molten layer are changed in the thickness-wise direction of the crucible. Here, since the area of a molten portion is unchanged, the thickness of the crucible is changed, and thus the weight of the crucible is changed.

Therefore, if the position of an electrode is controlled to control distribution of the heating state inside the mold, the total amount of heating is changed, and thus the weight of a crucible, which is affected by the amount of fusing that is nearly proportional to the amount of heating, may be changed. As a result, the weight of a crucible may be changed if control of the inner surface property of a crucible is attempted. For reduction of such a change in the weight of a crucible, that is, for controlling the total amount of heating at a predetermined state, an amount of power supplied during an arc heating may be changed.

However, since heating is performed by supplying very high current (power) of about 1000 A to about 3000 A during manufacturing of a vitreous silica crucible, variations significantly affecting the heating state, such as Lorentz vibration between electrodes or the like, may occur according to a variation in the amount of supplied power, and thus it is difficult to control a change in the heating state according to a variation in the amount of supplied power during arc heating to control the above adverse effect. Therefore, there is demand for controlling the inner surface state at a desired state and also manufacturing a vitreous silica crucible in a state of restraining weight-wise non-uniformity within a predetermined range.

In particular, in the case of manufacturing a large crucible with a crucible diameter above 60 cm, an area considering a distribution of the inner surface properties is large, and thus, when the height position of an electrode is controlled so that the inner surface of a crucible is in a desired state, non-uniformity of the weight of a vitreous silica crucible according to a variation in the total amount of heating increases. Furthermore, non-uniformity of the weight may occur at a scale that is incomparably larger as compared to the case of a crucible with a smaller diameter.

Here, an inner surface property of a vitreous silica crucible, which is referred to in the present invention, refers to all factors affecting properties of monocrystalline semiconductor pulled up from the vitreous silica crucible. In particular, the inner surface property of a vitreous silica crucible includes properties of the inner surface of a crucible, which is a portion contacting silicon melt that becomes a raw monocrystal material that is pulled up, or contacting silicon melt due to melt-out while the raw monocrystalline material is being pulled up, and properties of the crucible which affect the durability of the crucible that is to be heated for a long time. In detail, the inner surface properties of a vitreous silica crucible includes densities of bubbles, sizes of the bubbles, and impurity indexes in terms of distributions (uniformities, non-uniformities) in the thickness-wise direction of the crucible and in a direction along the inner surface of the crucible, and includes surface roughness, vitrification state, contents of OH groups, molten silicon wetness, or the like in terms of the inner surface shape of the crucible. Furthermore, the inner surface properties of a vitreous silica crucible may also refer to factors affecting properties of monocrystalline semiconductor pulled up from the vitreous silica crucible, such as distribution of bubbles and distribution of sizes of the bubbles in the thickness-wise direction of the crucible, distribution of impurities, surface roughness, vitrification status, and contents of OH groups in portions around the inner surface of the crucible, distribution such as nonuniformities thereof in the height-wise direction of the crucible, or the like.

Furthermore, in the case of simultaneously controlling the height position of an electrode and an amount of heat input, a switching response time from about 10⁻⁵ seconds to about 10⁻⁶ seconds is required for controlling supplied power (current). However, this requirement has not been realized for controlling high current in an apparatus for manufacturing a vitreous silica crucible.

Furthermore, no means that satisfies both controllability and durability required by apparatuses dealing with high current has yet been developed.

To solve the above problems, the present invention provides an apparatus for manufacturing a vitreous silica crucible, the apparatus capable of stably manufacturing a high quality vitreous silica crucible with good inner surface properties by reducing nonuniformity of weight by stabilizing generation of heat through arc discharge.

According to an aspect of the present invention, there is provided an apparatus 1 for manufacturing a vitreous silica crucible, the apparatus 1 including a mold 11 for defining a shape of the vitreous silica crucible; carbon electrodes 12a through 12c for generating an arc discharge for fusing silica powder deposited in the mold; and a power supply device 15. The power supply device includes a saturable reactor 21, 31 provided on a path for supplying power to the carbon electrodes and having a variable reactance; and a control device 29, 35 for controlling the power supplied to the electrodes by changing the reactance of the saturable reactor.

Furthermore, the apparatus for manufacturing a vitreous silica crucible according to the present invention includes a detector 26 for detecting at least one of a current and a voltage outputted from the power supply device, wherein the control device changes the reactance of the saturable reactor based on a result of the detection by the detector.

Here, the control device, referring to the result of the detection by the detector, may change the reactance of the saturable reactor, such that a variation over time in current or power outputted from the power supply device follows a predetermined variation over time in current or power for manufacturing the vitreous silica crucible.

Alternatively, the apparatus for manufacturing a vitreous silica crucible according to the present invention may include a temperature detector 14 for detecting the temperature of the silica powder fused by the arc discharge, wherein the control device changes the reactance of the saturable reactor based on a result of detection by the temperature detector.

Here, the control device may refer to the result of the detection by the temperature detector and may change the reactance of the saturable reactor, such that a variation over time in the temperature of the silica powder fused by the arc discharge follows a predetermined variation over time in the temperature for manufacturing the vitreous silica crucible.

Furthermore, in the apparatus for manufacturing a vitreous silica crucible according to the present invention, the power supply device includes a step-down transformer for stepping down a voltage inputted to a primary coil side and outputting the stepped down voltage to a secondary coil side, and the saturable reactor is provided at the primary coil side of the step-down transformer.

Furthermore, in the apparatus for manufacturing a vitreous silica crucible according to the present invention, the power supply device includes a first fixed reactor 34a through 34c connectable in parallel to the saturable reactor and having a fixed reactance; and a contactor 33a through 33c for switching on or off of parallel connection of the first fixed reactor and the saturable reactor, and wherein the control device controls power supplied to the electrodes by controlling the saturable reactor and also controlling the connection or disconnection by the contactor.

Furthermore, in the apparatus for manufacturing a vitreous silica crucible according to the present invention, a plurality of the first fixed reactor may be connected to the saturable reactor in parallel, and the reactance of the saturable reactor may be greater than the largest reactance from among the reactance of the first fixed reactor.

Furthermore, in the apparatus for manufacturing a vitreous silica crucible according to the present invention, the power supply device includes second fixed reactor 24, 32 connected to an output side of the saturable reactor in series and having a fixed reactance.

Furthermore, in the apparatus for manufacturing a vitreous silica crucible according to the present invention, the power supply device includes a third fixed reactor 22 provided at an output side of the saturable reactor and the third fixed reactor is energized only at a time of an arc discharge.

An apparatus for manufacturing a vitreous silica crucible according to the present invention includes a mold for defining a shape of the vitreous silica crucible; electrodes for generating an arc discharge for fusing silica powder deposited in the mold; and a power supply device, wherein the power supply device includes a saturable reactor provided on a path for supplying power to the electrodes and having a variable reactance; and a control device for controlling the power supplied to the electrodes by changing the reactance of the saturable reactor. Therefore, the reactance of the saturable reactor may be continuously changed, and thus power supplied to the electrodes may also be continuously changed. As a result, generation of heat through an arc discharge may be stabilized, and thus a high quality vitreous silica crucible may be stably manufactured.

Furthermore, the apparatus for manufacturing a vitreous silica crucible according to the present invention includes a detector for detecting at least one of a current and a voltage outputted from the power supply device, wherein the control device changes the reactance of the saturable reactor based on a result of the detection by the detector. Therefore, the power supplied to the electrodes may be controlled with high precision via feedback control based on at least one of a current and a voltage outputted from the power supply device.

Here, the control device refers to a result of the detection by the detector and changes the reactance of the saturable reactor, such that a variation over time in current or power outputted from the power supply device follows a predetermined variation over time in current or power for manufacturing a vitreous silica crucible. Therefore, a high quality vitreous silica crucible having a transparent vitreous silica layer with a uniform thickness and a significantly low content rate of bubbles may be stably manufactured.

Alternatively, the apparatus for manufacturing a vitreous silica crucible according to the present invention includes a temperature detector for detecting the temperature of the silica powder fused by the arc discharge, wherein the control device changes the reactance of the saturable reactor based on a result of detection by the temperature detector. Therefore, heat generated through an arc discharge may be controlled with high precision via feedback control based on the temperature of silica powder that is being fused.

Here, the control device, referring to the result of the detection by the temperature detector, changes the reactance of the saturable reactor, such that a variation over time in the temperature of the silica powder fused by the arc discharge follows a variation over time in the temperature to be changed for manufacturing the vitreous silica crucible. Therefore, a high quality vitreous silica crucible having a transparent vitreous silica layer with a uniform thickness and a significantly low content rate of bubbles may be stably manufactured.

Furthermore, in the apparatus for manufacturing a vitreous silica crucible according to the present invention, the power supply device includes a step-down transformer for stepping down a voltage inputted to a primary coil side and outputting the stepped down voltage to a secondary coil side, and the saturable reactor is provided at the primary coil side of the step-down transformer. Therefore, a current flowing in the saturable reactor may be smaller as compared to the case in which the saturable reactor is provided at the secondary coil side of the transformer. Furthermore, if it is not necessary to reduce the current flowing in the saturable reactor, the saturable reactor may be provided at the secondary coil side of the transformer.

Furthermore, in the apparatus for manufacturing a vitreous silica crucible according to the present invention, the power supply device includes a first fixed reactor connectable in parallel to the saturable reactor and having a fixed reactance; and a contactor for switching on or off of parallel connection of the first fixed reactor and the saturable reactor, and the control device controls power supplied to the electrodes by controlling the saturable reactor and also controlling connection and disconnection by the contactor. Therefore, the reactance of the power supply device may be changed step-by-step by controlling the contactor, and the reactance of the power supply device may be changed continuously by controlling the saturable reactor. Accordingly, the reactance of the power supply device may be continuously changed within a wide range.

Furthermore, in the apparatus for manufacturing a vitreous silica crucible according to the present invention, a plurality of the first fixed reactors may be connected to the saturable reactor, and the reactance of the saturable reactor is greater than the largest reactance from among the reactance of the first fixed reactor. Therefore, the reactance of the power supply device may be continuously changed even in case of changing the reactance of the power supply device within a wide range.

Furthermore, in the apparatus for manufacturing a vitreous silica crucible according to the present invention, the power supply device includes a second fixed reactor connected to an output side of the saturable reactor in series and having a fixed reactance. Therefore, variation in current in a short time may be suppressed.

Furthermore, in the apparatus for manufacturing a vitreous silica crucible according to the present invention, the power supply device includes a third fixed reactor provided at an output side of the saturable reactor and the third fixed reactor is energized only at a time of an arc discharge. Therefore, a current flowing at the time of starting an arc discharge may be stabilized.

According to the present invention, since the reactance of a saturable reactor provided on a power supply path may be changed continuously, power supplied to electrodes may also be changed continuously, and thus generation of heat through an arc discharge may be stabilized. As a result, a high quality vitreous silica crucible with a uniform thickness and a significantly low content rate of bubbles may be stably manufactured.

### BRIEF DESCRIPTION OF THE DRAWINGS

FIG. 1 is a diagram schematically showing an apparatus for manufacturing a vitreous silica crucible according to a first embodiment of the present invention.

FIG. 2 is a block diagram showing configurations of the major components of a power supply device included in the apparatus for manufacturing a vitreous silica crucible according to the first embodiment of the present invention.

FIG. 3 is a diagram showing an example of a saturable reactor.

FIG. 4 is a diagram showing an example of temperature changes over time while a vitreous silica crucible is being manufactured according to the first embodiment of the present invention.

FIG. 5 is a block diagram showing configurations of the major components of a power supply device included in an apparatus for manufacturing a vitreous silica crucible according to a second embodiment of the present invention.

### DESCRIPTION OF THE PREFERRED EMBODIMENTS

Hereinafter, the present invention will be described in detail by explaining exemplary embodiments of the invention with reference to the attached drawings.

### First Embodiment

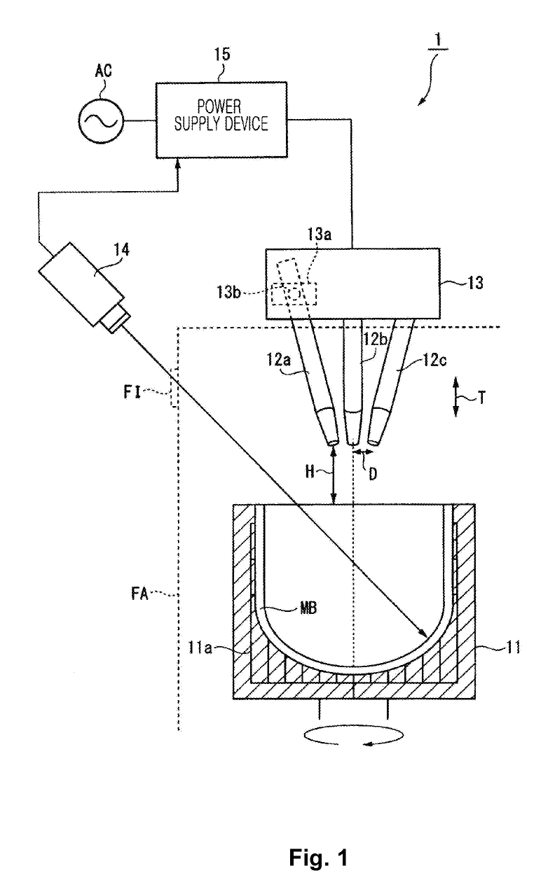

FIG. 1 is a diagram schematically showing an apparatus for manufacturing a vitreous silica crucible according to a first embodiment of the present invention. As shown in FIG. 1, the apparatus 1 for manufacturing a vitreous silica crucible includes a spinning mold (a mold) 11, carbon electrodes 12a, 12b, and 12c (electrodes), an electrode position setting unit 13, a radiation thermometer 14 (a temperature detector), and a power supply device 15. The apparatus 1 manufactures a vitreous silica crucible having a transparent vitreous silica layer formed inside an opaque vitreous silica layer by fusing silica powder deposited in the mold 11 through an arc discharge and holding the molten silica under depressurized conditions.

The mold 11 defines a shape of a vitreous silica crucible to be manufactured, is formed of carbon or the like, and is housed in an arc furnace FA, where the mold 11 may be rotated by a rotation unit (not shown). Silica powder molded body MB is formed by supplying raw powder (silica powder) to the mold 11 in a predetermined thickness. In the mold 11, a plurality of ventilation holes 11a which penetrate the mold 11 to the inner surface of the mold 11 and are connected to a depressurization unit (not shown) are provided, and thus the interior of the silica powder molded body MB may be depressurized via the ventilation holes 11a.

The carbon electrodes 12a, 12b, and 12c are electrodes which generate an arc discharge for fusing the silica powder molded body MB, are held in the electrode position setting unit 13, and are arranged above the mold 11 in the arc furnace FA. For example, the carbon electrodes 12a, 12b, and 12c are rod-type electrodes having a same shape for generating a 3-phase (R-phase, S-phase, and T-phase) alternating arc discharge and are held by the electrode position setting unit 13, such that the carbon electrodes 12a, 12b, and 12c are arranged in the shape of a reversed triangular pyramid having the vertex at the bottom. Furthermore, although the configuration having the three carbon electrodes 12a, 12b, and 12c is provided for describing the present embodiment, the number of the carbon electrodes, the arrangement of the carbon electrodes, and the method of supplying power to the carbon electrodes are not limited thereto, and any of various configurations may be employed.

The carbon electrodes 12a, 12b, and 12c may be moved by the electrode position setting unit 13 in vertical directions indicated by the arrow (T) in FIG. 1, and the height-wise position H of the carbon electrodes 12a, 12b, and 12c with respect to the mold 11 (the height-wise position H with respect to the top of the silica powder molded body MB (the top of the opening of the mold 11)) is variable. Furthermore, intervals between the leading end portions of the carbon electrodes 12a, 12b, and 12c (the inter-electrode distances D) may be changed by the electrode position setting unit 13, and relative positions of the carbon electrodes 12a, 12b, and 12c other than the height-wise position H with respect to the mold 11 are also variable.

The carbon electrodes 12a, 12b, and 12c are formed of high purity carbon particles having diameters less than or equal to 0.3 mm, preferably less than or equal to 0.1 mm, and more preferably less than or equal to 0.05 mm. When a density of the high purity carbon particles is from 1.30 g/cm³ to 1.80 g/cm³ or from 1.30 g/cm³ to 1.70 g/cm³, differences between the densities of the carbon electrodes 12a, 12b, and 12c are less than or equal to 0.2 g/cm³. Accordingly, the carbon electrodes 12a, 12b, and 12c have high homogeneity.

The electrode position setting unit 13 is arranged above the arc furnace FA, holds the carbon electrodes 12a, 12b, and 12c in position above the mold 11, and supplies power, which is supplied from the power supply device 15, to each of the carbon electrodes 12a, 12b, and 12c. The electrode position setting unit 13 includes a supporting unit 13a, which holds the carbon electrodes 12a, 12b, and 12c in position capable of varying the inter-electrode distances D, a horizontal transportation unit, which transports the supporting unit 13a in horizontal directions, and a vertical transportation unit, which transports a plurality of the supporting units 13a and the horizontal transportation unit of the plurality of supporting units 13a together in vertical directions.

The supporting unit 13a supports the carbon electrode 12a, such that the carbon electrode 12a may rotate around an angle setting shaft 13b. The inter-electrode distance D may be adjusted by controlling the angle of the carbon electrode 12a around the angle setting shaft 13b and controlling the horizontal position of the supporting unit 13a by using the horizontal transportation unit. Furthermore, the height-wise position H of the carbon electrode 12a with respect to the mold 11 may be adjusted by controlling the height-wise position of the supporting unit 13a by using the vertical transportation unit.

Furthermore, although FIG. 1 shows only the supporting unit 13a which supports the carbon electrode 12a, supporting units which support the carbon electrodes 12b and 12c are also provided in the electrode position setting unit 13, and the horizontal transportation unit and the vertical transportation unit are also provided with respect to each of the supporting units. Therefore, angles around angle setting shafts, horizontal positions, and height positions of the carbon electrodes 12a, 12b, and 12c may be independently controlled. The controlling stated above is performed by a control unit (not shown).

The radiation thermometer 14 is arranged outside the arc furnace FA and measures the temperature of a molten portion of the silica powder molded body MB formed inside the mold 11 via a filter FI covering a window provided in the partitioning wall of the arc furnace FA. The radiation thermometer 14 includes an optical system which collects radiation energy from the molten portion or the like, a spectroscopic unit which spectrally separates light collected by the optical system, and a detecting device which detects light separated by the spectroscopic unit, and outputs a result of detection by the detecting device (a result of measuring temperature) to the power supply device 15.

In detail, the radiation thermometer 14 is set to measure a target wavelength from 4.8 μm to 5.2 μm and a temperature from several hundred ° C. to several thousand ° C. Here, the radiation thermometer 14 is set to measure a target wavelength from 4.8 μm to 5.2 μm in order to avoid radiation energy with wavelengths from 4.2 μm to 4.6 μm, which belong to a wavelength band absorbed by CO₂, and wavelengths from 5.2 μm to 7.8 μm, which belong to a wavelength band absorbed by H₂O included in the atmosphere when manufacturing a vitreous silica crucible and to detect radiation energy with wavelengths from 4.8 μm to 5.2 μm, and thus the radiation thermometer 14 measures a temperature. Furthermore, the filter FI may be formed of BaF₂ or CaF₂, which less likely absorbs wavelengths belonging to the wavelength band.

The power supply device 15 is provided with power from a commercial alternating current source AC to power supply device, and generates an arc discharge for fusing the silica powder molded body MB by controlling power supplied to the carbon electrodes 12a, 12b, and 12c based on a measurement result of the radiation thermometer 14 or the like. In detail, the power supply device 15 controls the power supplied to the carbon electrodes 12a, 12b, and 12c to be within a range from several hundred kVA to tens of thousands of kVA.

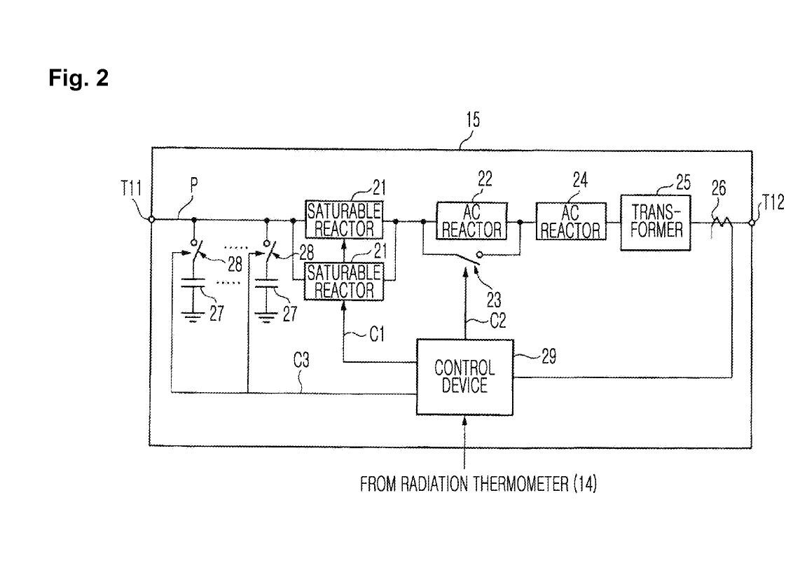

FIG. 2 is a block diagram showing configurations of the major components of a power supply device included in the apparatus for manufacturing a vitreous silica crucible according to the first embodiment of the present invention. As shown in FIG. 2, the power supply device 15 includes a saturable reactor 21, an alternating current (AC) reactor 22 (a third fixed reactor), a contactor 23, an AC reactor 24 (a second fixed reactor), a transformer 25 (a step-down transformer), a detector 26, a condenser 27, a contactor 28, and a control device 29. From among the components stated above, the components from the saturable reactor 21 through to the detector 26 are provided on a power supply path P between a connection terminal T11 connected to the alternating current source AC and a terminal T12 connected to the carbon electrodes 12a through 12c. Furthermore, the condenser 27 and the contactor 28 are connected to the power supply path P in parallel. Furthermore, although FIG. 2 shows a simplified form, the present embodiment provides that both the power supplied from the alternating current source AC and the power supplied to the carbon electrodes 12a, 12b, and 12c are in the form of 3-phase alternating current. Therefore, the power supply path P is actually formed of three lines supplying currents of each layer of a 3-phase alternating current, and the three lines are Y-connected (star-connected), for example.

The saturable reactor 21 has variable reactance and adjusts a current supplied from the alternating current source AC to the power supply path P via the connection terminal T11. Here, in the embodiment shown in FIG. 2, the two saturable reactors 21 are connected in parallel to control the power supplied to the carbon electrodes 12a, 12b, and 12c within a range from several hundred kVA to tens of thousands of kVA. Furthermore, if one of the saturable reactors 21 is capable of controlling power within this range, it is not necessary to connect a plurality of the saturable reactors 21 in parallel. The reactance of the saturable reactor 21 is controlled by a control signal C1 of a direct current outputted from the control device 29.

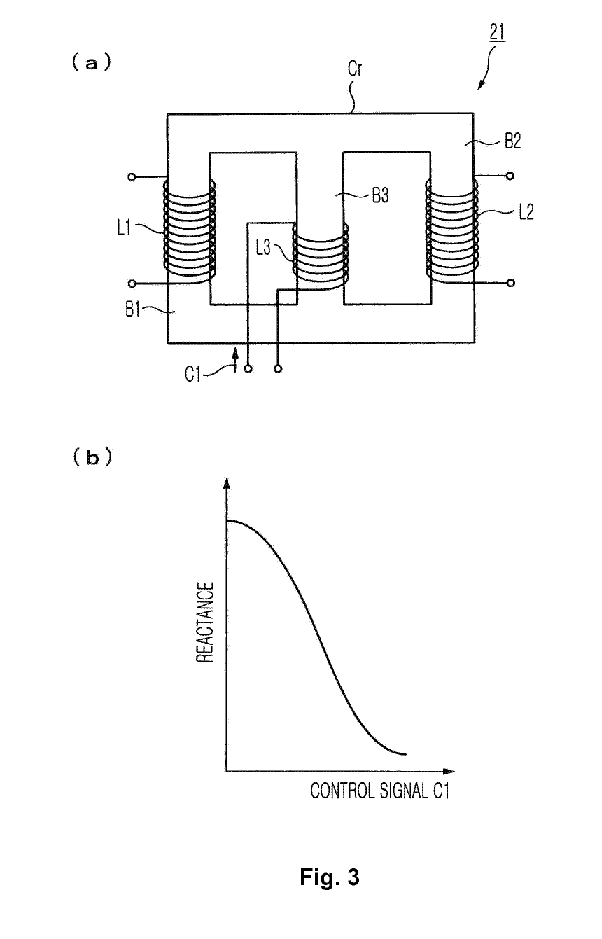

FIG. 3 is a diagram showing an example of saturable reactors, where FIG. 3(a) shows an example of basic configurations, and FIG. 3(b) shows an example of reactance variation characteristics. The saturable reactor 21 shown in FIG. 3(a) includes a primary coil L1 electrically connected to the connection terminal T11, a secondary coil L2 electrically connected to the AC reactor 22, a control coil L3 supplied the control signal C1, and a trans core Cr including column units B1, B2, and B3 around which the primary coil L1, the secondary coil L2, and the control coil L3 are respectively wound.

If the control signal C1 is not outputted from the control device 29, magnetic flux is generated in the trans core Cr along a current supplied to the primary coil L1. On the other hand, if the control signal C1 is outputted from the control device 29, a porcelain saturation amount of the trans core Cr is adjusted according to the intensity of the control signal C1. Therefore, as shown in FIG. 3(b), as the control signal C1 intensifies, the reactance of the saturable reactor 21 decreases. When the reactance decreases, the amount of current increases, and thus the amount of current outputted from the saturable reactor 21 may be controlled by using the control signal C1.

The AC reactor 22 is a reactor with a fixed reactance, which is provided to stabilize a current flowing at the time of starting an arc discharge and is arranged on the power supply path P at the output side of the saturable reactor 21. The contactor 23, opening/closing states of which are controlled by a control signal C2 outputted from the control device 29, is connected to the AC reactor 22 in parallel. When the contactor 23 is closed, the saturable reactor 21 and the AC reactor 24 may be short circuited. Under control of the control device 29, the contactor 23 is opened at the time of starting the arc discharge and is closed at other times. Therefore, although the current outputted from the saturable reactor 21 flows in the AC reactor 22 at the time of starting the arc discharge, the current outputted from the saturable reactor 21 flows into the AC reactor 24 via the contactor 23 and does not flow in the AC reactor 22 at other times.

The AC reactor 24 is a reactor with a fixed reactance, which is provided to suppress variation in current in a short period of time and is arranged on the power supply path P at the output side of the AC reactor 24. The transformer 25 is a 3-phase transformer which transforms the voltage of a 3-phase current, steps down a voltage inputted to the primary coil side, and outputs the stepped down voltage to the secondary coil side. Furthermore, as shown in FIG. 2, the saturable reactor 21 is provided at the primary coil side of the transformer 25. Accordingly, a current flowing in the saturable reactor 21 may be smaller as compared to the case in which the saturable reactor 21 is provided at the secondary coil side of the transformer 25.

The detector 26 includes a current sensor and a voltage sensor, is provided at the secondary coil side of the transformer 25, and detects the output current and the output voltage of the transformer 25 (that is, the output current and the output voltage of the power supply device 15). Furthermore, although the present embodiment provides an example in which the detector 26 detects both of the output current and the output voltage of the power supply device 15, the detector 26 may detect only the output current or the output voltage. Results of the detection by the detector 26 are outputted to the control device 29.

The condenser 27 is a condenser for adjusting power factor and is connected in parallel to the power supply path P between the connection terminal T11 and the saturable reactor 21 via the contactor 28, opening/closing states of which are controlled according to a control signal C3 outputted from the control device 29. The condenser 27 is connected to the power supply path P when the contactor 28 is closed, and is separated from the power supply path P when the contactor 28 is opened. A plurality of circuits each consisting of the condenser 27 and the contactor 28 are connected in parallel to a power supply path P, and opening/closing states of the contactors 28 of the circuits are controlled based on active power and reactive power calculated using the results of the detection by the detector 26. Furthermore, the number of the circuits each consisting of the condenser 27 and the contactor 28 and the capacities of the condensers 27 may be determined according to the precision of power factor adjustment.

The control device 29 controls the power supplied to the carbon electrodes 12a, 12b, and 12c by controlling the reactance of the saturable reactor 21 by outputting the control signal C1 to the saturable reactor 21. Here, the control device 29 controls the reactance of the saturable reactor 21 based on at least one of a result of detection by the detector 26 and a measurement result of the radiation thermometer 14.

In the case of controlling the reactance of the saturable reactor 21 based on the result of detection by the detector 26, the control device 29 refers to power calculated from a current or both of a current and a voltage detected by the detector 26 and changes the reactance of the saturable reactor 21, such that a variation over time in current or power outputted from the power supply device 15 follows a predetermined variation over time in current or power for manufacturing a vitreous silica crucible. In the case of controlling the reactance of the saturable reactor 21 based on the measurement result of the radiation thermometer 14, the control device 29 refers to the measurement result of the radiation thermometer 14 and changes the reactance of the saturable reactor 21, such that a variation over time in the temperature of the silica powder molded body MB fused by the arc discharge follows a predetermined variation over time in the temperature for manufacturing a vitreous silica crucible.

Furthermore, to stabilize a current flowing at the time of starting arc discharge, the control device 29 controls opening/closing states of the contactor 23 by outputting the control signal C2 at the time of starting the arc discharge. Furthermore, to adjust the power factor, the control device 29 calculates active power and reactive power by using the result of detection by the detector 26 and controls opening/closing state of each of the contactors 28 by outputting the control signal C3.

Next, operation of an apparatus for manufacturing a vitreous silica crucible while the vitreous silica crucible is being manufactured will be described. First, the silica powder molded body MB is formed by supplying the interior of the mold 11 with silica powder to a predetermined thickness (supplying process). Next, plasma is generated by an arc discharge, and the silica powder molded body MB is fused by the heat of the plasma and becomes vitreous silica (fusing process). When the fusing process is started, the control signal C2 is outputted from the control device 29, and thus the contactor 23 is opened. Therefore, the current outputted from the saturable reactor 21 is inputted to the transformer 25 sequentially via the AC reactor 22 and the AC reactor 24, and thus a current flowing at the time of starting the arc discharge is stabilized.

When a predetermined period of time has elapsed after starting of arc discharge, the control signal C2 is outputted from the control device 29, and thus the contactor 23 is closed. Therefore, the current outputted from the saturable reactor 21 is inputted to the transformer 25 sequentially via the contactor 23 and the AC reactor 24. After the controlling described above is completed, the reactance of the saturable reactor 21 is controlled by the control device 29 based on at least one of the result of the detection by the detector 26 and the measurement result of the radiation thermometer 14.

In detail, the control signal C2 is outputted from the control device 29, and the reactance of the saturable reactor 21 is controlled, such that a variation over time in current or power outputted from the power supply device 15 follows a predetermined variation over time in current or power for manufacturing a vitreous silica crucible. Alternatively, the reactance of the saturable reactor 21 is controlled, such that a variation over time in the temperature of the silica powder molded body MB fused by the arc discharge follows a predetermined variation over time in the temperature for manufacturing a vitreous silica crucible.

For example, in the case when power detected by the detector 26 is smaller than target power, the control device 29 outputs the control signal C2 and reduces the reactance of the saturable reactor 21, and thus an output current is increased. On the contrary, in the case when power detected by the detector 26 is greater than the target power, the control device 29 outputs the control signal C2 and increases the reactance of the saturable reactor 21, and thus the output current is reduced. As shown in FIG. 3(b), the reactance of the saturable reactor 21 may be continuously changed, and thus output current of the power supply device 15 may also be continuously changed.

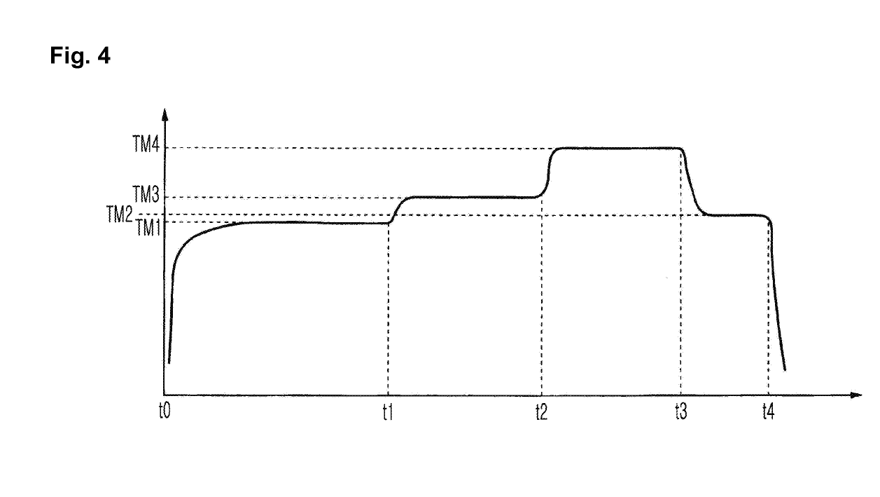

FIG. 4 is a diagram showing an example of temperature changes over time while a vitreous silica crucible is being manufactured according to the first embodiment of the present invention. As shown in FIG. 4, a temperature begins to rise from a time point t0, and, when the temperature reaches a point TM1, the temperature is maintained at the point TM1 until a time point t1. At the time point t1, the temperature begins to rise again, and, when the temperature reaches a point TM3, the temperature is maintained at the point TM3 until a time point t2. At the time point t2, the temperature begins to rise again, and, when the temperature reaches a point TM4, the temperature is maintained at the point TM4 until a time point t3. At the time point t3, the temperature begins to drop, and, when the temperature drops to a point TM2 between the points TM1 and TM3, the temperature is maintained at the point TM2 until a time point t4. The temperature drops to room temperature (e.g., 25° C.) thereafter.

As described above, according to the present embodiment, a current flowing in the saturable reactor 21 may be continuously changed, and thus power of the power supply device 15, which is changed due to a variation in the power supplied from the alternating current source AC or arc atmosphere inside the arc furnace FA, may be continuously controlled. Accordingly, the power supplied to the carbon electrodes 12a, 12b, and 12c is stabilized, and thus generation of heat through an arc discharge is stabilized. As a result, a high quality vitreous silica crucible may be stably manufactured.

### Second Embodiment

Next, an apparatus for manufacturing a vitreous silica crucible according to a second embodiment of the present invention will be described in detail. The overall configuration of the apparatus for manufacturing a vitreous silica crucible according to the present embodiment is identical to the apparatus 1 for manufacturing a vitreous silica crucible according to the first embodiment shown in FIG. 1 and includes the components from the mold 11 through to the power supply device 15. However, the apparatus for manufacturing a vitreous silica crucible according to the present embodiment has a power supply device having a different configuration from the power supply device (the power supply device 15 shown in FIG. 2) of the apparatus for manufacturing a vitreous silica crucible according to the first embodiment of the present invention.

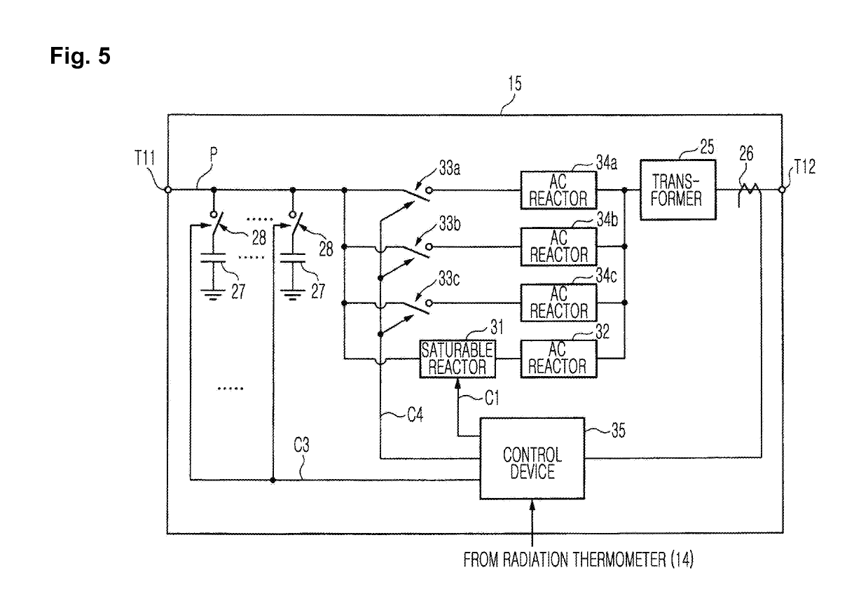

FIG. 5 is a block diagram showing configurations of the major components of a power supply device included in the apparatus for manufacturing a vitreous silica crucible according to the second embodiment of the present invention. Furthermore, blocks shown in FIG. 5 that are identical to the blocks shown in FIG. 2 are denoted by the same reference numerals. As shown in FIG. 5, the power supply device 15 of the apparatus for manufacturing a vitreous silica crucible according to the present embodiment provides a saturable reactor 31, an AC reactor 32 (a second fixed reactor), contactors 33a through 33c, AC reactors 34a through 34c (first fixed reactors) instead of the saturable reactor 21 through to the AC reactor 24 provided the power supply device 15 shown in FIG. 2, and provides a control device 35 instead of the control device 29.

The saturable reactor 31 has the same configuration as the saturable reactor 21 according to the first embodiment of the present invention. In other words, the saturable reactor 31 has variable reactance and adjusts a current supplied from the alternating current source AC to the power supply path P via the connection terminal T11. The AC reactor 32 has the same configuration as the AC reactor 24 according to the first embodiment of the present invention. In other words, the AC reactor 32 is a reactor with a fixed reactance, which is provided to suppress a variation in current over a short period of time, and is connected to the saturable reactor 31 in series.

A circuit formed by serial connection of the contactor 33a and the AC reactor 34a, a circuit formed by serial connection of the contactor 33b and the AC reactor 34b, and a circuit formed by serial connection of the contactor 33c and the AC reactor 34c are respectively connected in parallel to a circuit formed by serial connection of the saturable reactor 31 and the AC reactor 32. Opening/closing states of the contactors 33a through 33c are controlled by a control signal C4 outputted from the control device 35, and thus the parallel connections or disconnections of the AC reactors 34a through 34c to the circuit formed by the serial connection between the saturable reactor 31 and the AC reactor 32 are determined by the contactors 33a through 33c. If the contactor 33a is closed, the AC reactor 34a is connected to the AC reactor 32 in parallel. If the contactor 33b is closed, the AC reactor 34b is connected to the AC reactor 32 in parallel. If the contactor 33c is closed, the AC reactor 34c is connected to the AC reactor 32 in parallel.

The AC reactors 34a through 34c are reactors with fixed reactance, which are provided to significantly change the reactance of the power supply device 15 step-by-step. In other words, according to the present embodiment, the reactance of the power supply device 15 is changed step-by-step by connecting or disconnecting the AC reactors 34a through 34c connected with the saturable reactor 31 in parallel by controlling the contactors 33a through 33c, and the reactance of the power supply device 15 is continuously changed by controlling the saturable reactor 31. Therefore, the reactance of the saturable reactor 31 is set to be greater than the largest reactance from among the reactance of the AC reactors 34a through 34c.

Furthermore, a current flowing at the time of starting an arc discharge may be easily stabilized by providing the AC reactors 34a through 34c, and thus the AC reactor 22 shown in FIG. 2 is omitted in the present embodiment. However, to further stabilize the current flowing at the time of starting the arc discharge, a circuit formed due to parallel connection between the AC reactor 22 and the contactor 23 as shown in FIG. 2 may also be provided between the saturable reactor 31 and the AC reactor 32 even in the present embodiment.

The control device 35 is basically identical to the control device 29 shown in FIG. 2. However, in addition to controls of the saturable reactor 31 and the contactor 28, the control device 35 controls the contactors 33a through 33c. In detail, the control device 35 changes the reactance of the power supply device 15 step-by-step by changing a number of the AC reactors 34a through 34c connected to the AC reactor 32 in parallel by controlling opening/closing states of the contactors 33a through 33c by outputting a control signal C4, and continuously changes the reactance of the saturable reactor 31 by outputting a control signal C1.

Furthermore, the reactance of the power supply device 15 is controlled, such that a variation over time in current or power outputted from the power supply device 15 follows a predetermined variation over time in current or power for manufacturing a vitreous silica crucible. Alternatively, the reactance of the power supply device 15 is controlled, such that a variation over time in the temperature of the silica powder molded body MB fused by the arc discharge follows a predetermined variation over time in the temperature for manufacturing a vitreous silica crucible.

As described above, according to the present embodiment, the reactance may be changed step-by-step by controlling the contactors 33a through 33c, and, at the same time, the reactance may be changed continuously by controlling the saturable reactor 31. Therefore, the reactance of the power supply 15 may be continuously changed within a wide range even by using the saturable reactor 31 having a relatively small capacity. Here, a saturable reactor is generally more expensive than an AC reactor and a contactor, and thus costs may be reduced by employing an AC reactor and a contactor to configure the present embodiment.

While the apparatus for manufacturing a vitreous silica crucible according to the above embodiments has been described, the present invention is not limited thereto and various modifications or changes can be made within the scope of the present invention defined by the claims. For example, controlling may be performed not only by using one of a result of detection by the detector 26 and a measurement result of the radiation thermometer 14, but also by using both of the results. Furthermore, although examples of manufacturing a vitreous silica crucible only by controlling the power outputted from the power supply device 15 (the power supplied to the carbon electrodes 12a, 12b, and 12c) have been described above in the above embodiments, a vitreous silica crucible may be manufactured by controlling the height-wise positions or the inter-electrode distances D of the carbon electrodes 12a, 12b, and 12c in addition to controlling the power.

### EXPLANATION OF REFERENCE NUMERALS

1: apparatus for manufacturing a vitreous silica crucible
11: mold
12a-12c: carbon electrodes
14: radiation thermometer
15: power supply device
21: saturable reactor
22: AC reactor
24: AC reactor
25: transformer
26: detector
29: control device
31: saturable reactor
32: AC reactor
33a˜33c: contactors
34a˜34c: AC reactors
35: control device
MB: silica powder molded body

What is claimed is:

1. A method of manufacturing a vitreous silica crucible by use of an apparatus for manufacturing a vitreous silica crucible, the apparatus comprising:
a mold for defining a shape of the vitreous silica crucible;
electrodes for generating an arc discharge for fusing silica powder layer deposited in the mold;
a radiation thermometer for detecting the temperature of the silica powder fused by the arc discharge; and
a power supply device for supplying power to the electrodes, wherein
the method comprises a process of fusing the silica powder deposited in the mold by arc discharge generated by the electrodes to which power is supplied;
wherein the power supply device comprises:
a saturable reactor provided on a path for supplying power to the electrodes and having a variable reactance; and
a control device for controlling the power supplied to the electrodes by changing the reactance of the saturable reactor, and wherein
the control device, referring to the result of the detection by the radiation thermometer, changes the reactance of the saturable reactor, such that a variation over time in the temperature of the silica powder fused by the arc discharge follows a predetermined variation over time in a temperature for manufacturing the vitreous silica crucible.

2. The method of claim 1, wherein the apparatus further comprises a detector for detecting at least one of a current and a voltage outputted from the power supply device,
wherein the control device changes the reactance of the saturable reactor based on a result of the detection by the detector.

3. The method of claim 2, wherein the control device, referring to the result of the detection by the detector, changes the reactance of the saturable reactor, such that a variation over time in current or power outputted from the power supply device follows a predetermined variation over time in current or power for manufacturing the vitreous silica crucible.

4. The method of claim 1,
wherein the control device changes the reactance of the saturable reactor based on a result of detection by the radiation thermometer.

5. The method of claim 1, wherein the power supply device comprises a step-down transformer for stepping down a voltage inputted to a primary coil side and outputting the stepped down voltage to a secondary coil side, and
the saturable reactor is provided at the primary coil side of the step-down transformer.

6. The method of claim 5, wherein the power supply device comprises:
a first fixed reactor connectable in parallel to the saturable reactor and having a fixed reactance; and
a contactor for switching on or off of parallel connection of the first fixed reactor and the saturable reactor, and wherein
the control device controls power supplied to the electrode by controlling the saturable reactor and also controlling the connection and disconnection by the contactor.

7. The method of claim 6, wherein a plurality of the first fixed reactors are connectable to the saturable reactor, and
the reactance of the saturable reactors is greater than the largest reactance from among the reactance of the first fixed reactors.

8. The method of claim 5, wherein the power supply device comprises a second fixed reactor connected to an output side of the saturable reactor in series and having a fixed reactance.

9. The method of claim 5, wherein the power supply device comprises a third fixed reactor provided at an output side of the saturable reactor and the third fixed reactor is energized only at the beginning of an arc discharge.
